(19) United States
(12) Patent Application Publication
(10) Pub. No.: US 2021/0302396 A1
(43) Pub. Date: Sep. 30, 2021

(54) LARGE VOLUME SAMPLE INJECTION FOR LIQUID CHROMATOGRAPHY

(71) Applicant: Waters Technologies Corporation, Milford, MA (US)

(72) Inventors: Sylvain Gilles Cormier, Mendon, MA (US); Jason F. Hill, Milford, MA (US)

(21) Appl. No.: 17/210,924

(22) Filed: Mar. 24, 2021

Related U.S. Application Data
(60) Provisional application No. 63/002,391, filed on Mar. 31, 2020.

(51) Int. Cl. G01N 30/20; G01N 35/10; G01N 30/02

(52) U.S. Cl. CPC G01N 30/20; G01N 35/1097; G01N 2030/201; G01N 2030/027; G01N 2030/207

(57) ABSTRACT

Described are methods and fluidic networks for injecting a sample into a liquid chromatography system. The method may be applied for separations in which increased sensitivity is desired and a large sample volume in a strong solvent is to be injected. The method may include merging a flow of a solvent having a sample dissolved therein with a flow of a diluent. The merging occurs in a fluidic path to an injection valve. The full amount of sample previously contained in a smaller volume of solvent is maintained in a larger volume of a diluted sample that includes the strong solvent and the diluent. The entire volume of the diluted sample is loaded into a sample loop coupled to the injection valve and subsequently injected into the system flow of the chromatography system.

### RELATED APPLICATION

This application claims the benefit of the earlier filing date of U.S. Provisional Patent Application Ser. No. 63/002,391, filed Mar. 31, 2020 and titled “Large Volume Sample Injection for Liquid Chromatography,” the entirety of which is incorporated herein by reference.

### FIELD OF THE INVENTION

The invention relates generally to liquid chromatography systems. More particularly, the invention relates to systems and methods for acquiring and diluting a chromatographic sample.

### BACKGROUND

Chromatography systems and methods can be applied to separate a mixture. In liquid chromatography, a sample containing a number of components to be separated is injected into a system flow and directed to a chromatographic column. The column separates the mixture by differential retention into its individual components. Typically, the components elute from the column as distinct bands separated in time.

A typical liquid chromatography system includes one or more pumps for delivering a fluid (the “mobile phase”) at a controlled flow rate and composition, an injector to introduce a sample solution into the flowing mobile phase, a chromatographic column that contains a packing material or sorbent (the “stationary phase”), and a detector to detect the presence and amount of the sample components in the mobile phase leaving the column. Some liquid chromatography systems may require that a sample be diluted before the sample is injected into the mobile phase flowing to the chromatography column. When the mobile phase passes through the stationary phase, each component of the sample typically emerges from the column at a different time because different components in the sample generally have different affinities for the packing material. The presence of a particular component in the mobile phase exiting the column may be detected by measuring changes in a physical or chemical property of the eluent. By plotting the detector signal as a function of time, response “peaks” corresponding to the presence and quantities of the components of the sample may be observed.

The manner of acquiring samples for analysis may be manually intensive. In some systems, an individual may take a sample manually from a sample via, process line or other source of sample, carry the sample to the liquid chromatography system, and load the sample for injection and subsequent analysis. Throughout the handling of the sample, care must be taken to label the sample properly and to ensure a well-documented chain of custody, or uncertainty may be introduced into the results. If the sample is to be diluted before injection, the individual typically washes the container within which the dilution will occur to avoid contamination with previously used samples. Moreover, a manually prepared dilution can be wasteful of sample, which can oftentimes be an expensive commodity.

Additionally, errors may occur during the liquid chromatography process or analysis and a mixture representative of the sample may not be available at a later time. In some situations, preparing the sample for liquid chromatography and/or performing the liquid chromatography process may take a disproportionate amount of time such that acquiring the sample to be analyzed at the proper time may not be practical.

### SUMMARY

In an aspect of the present disclosure, a method for injecting a sample into a liquid chromatography includes providing a first diluent flow in a fluid path coupled to an injection valve having a plurality of ports and a sample loop coupled between two of the ports. The fluid path having an end coupled to one of the ports. The injection valve is in a first valve state to conduct a chromatography system flow through the sample loop. A sample flow is merged with the first diluent flow to create a flow of a diluted sample in the fluid path. The sample flow includes a sample dissolved in a solvent and the diluted sample has a diluted sample volume. The sample flow and the first diluent flow are terminated so that the fluid path contains a first volume of diluent followed by the diluted sample. The injection valve is switched to a second valve state in which the fluid path is coupled to the sample loop. A second diluent flow is provided to the fluid path to push an entirety of the diluted sample from the fluid path into the sample loop with at least a portion of the diluent in the first diluent flow and a portion of the diluent in the second diluent flow in the sample loop. The injection valve is switched to the first valve state wherein the sample loop is inserted into the system flow to thereby inject the entirety of the diluted sample volume into the system flow.

The method may further include drawing the sample from a sample source prior to merging the sample flow with the portion of the first flow of the diluent.

The sample volume may be at least 1 μL. The diluted sample may have a diluted sample volume that is equal to the sum of the merged volumes of sample and diluent.

The first diluent flow and the second diluent flow may be flow of a same diluent. The sample flow and the first diluent flow may be terminated at the same time. Alternatively, the sample flow may be terminated before the first diluent flow so that the fluid path contains a first volume of diluent followed by the diluted sample volume followed by a second volume of diluent.

The method may further include providing a flow of a wash solvent through the fluid path coupled to the injection valve.

In another aspect of the present disclosure, a fluidic network for injecting a diluted sample into a liquid chromatography system includes an injection valve, a sample needle, an injection block, a sample syringe, a sample syringe valve, a diluent syringe, a diluent syringe valve and a processor. The injection valve has a plurality of ports wherein one of the ports is configured to receive a system flow of a liquid chromatography system and another one of the ports is configured to provide the system flow. The injection valve is configurable in at least two valve states and includes a sample loop that is coupled at each end to one of the ports. The sample syringe is configured to aspirate and to dispense a sample. The sample syringe valve is operable in at least two valve states, wherein, when the sample syringe valve is in a first valve state, the sample syringe is coupled to the sample needle. The diluent syringe is configured to aspirate and to dispense a diluent. The diluent syringe valve is operable in at least two valve states, wherein, when the diluent syringe valve is in a first valve state, the diluent syringe is coupled through the injection block and a fluid path to a port of the injection valve and wherein, when the diluent syringe valve is in a second valve state, the diluent syringe is coupled to a source of diluent. The processor is in communication with the injection valve, the sample syringe and the diluent syringe. The processor controls the valve state of the injection valve, a flow rate of a sample flow from the sample syringe and a flow rate of a diluent flow from the diluent syringe.

The sample syringe may be coupled to a source of wash solvent when the sample syringe valve is in a second valve state. The sample needle may be movable to enable coupling of the sample syringe valve to the injection block and to a source of sample.

The sample loop may have a volume of at least 100 microliters. The sample loop may have a volume that does not exceed one milliliter.

The fluidic network may further include a wash tower coupled to the injection block and configured to receive the sample needle.

In another aspect of the present disclosure, a fluidic network for injecting a diluted sample into a liquid chromatography system includes an injection valve, a sample needle, a sample syringe, a diluent syringe and a processor. The injection valve has a plurality of ports wherein one of the ports is configured to receive a system flow of a liquid chromatography system and another one of the ports is configured to provide the system flow. The injection valve is configurable in at least two valve states and includes a sample loop that is coupled at each end to one of the ports. The sample syringe is in communication with the sample needle and is configured to aspirate a sample through the sample needle and to dispense a sample into a fluid path to the injection valve. The diluent syringe is configured to aspirate a diluent from a source of diluent and to dispense the diluent into the fluid path to the injection valve. The processor is in communication with the injection valve, the sample syringe and the diluent syringe. The processor controls the valve state of the injection valve, a flow rate of a sample flow from the sample syringe and a flow rate of a diluent flow from the diluent syringe. A diluted sample is created by a merging of the sample flow and the diluent flow in the fluid path to the injection valve.

The sample loop may have a volume of at least 10 microliters. The sample needle may be movable to enable coupling of the sample syringe valve to the fluid path to the injection valve and to a source of sample.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the technology.

FIG. 1 is a block diagram of a liquid chromatography system that can be used to practice embodiments of a method for injecting a sample into a liquid chromatography system.

FIG. 2A is a chromatogram for a 1 μL sample dissolved in a solvent of 5% acetonitrile and 95% water.

FIG. 2B is a chromatogram for a 5 μL sample dissolved in a solvent of 75% acetonitrile and 25% water.

FIG. 2C is a chromatogram for a 10 μL sample dissolved in a solvent of 75% acetonitrile and 25% water.

FIG. 2D is a chromatogram for a 20 μL sample dissolved in a solvent of 75% acetonitrile and 25% water.

FIG. 3 is a flowchart representation of an example of a method for injecting a sample in a liquid chromatography system.

FIG. 4 is a schematic depiction of a fluidic network that can be used to perform the method of FIG. 3.

FIG. 5 shows the fluidic network configured to merge a diluent and a sample to create a volume of diluted sample.

FIG. 6 shows the fluidic network configured to load the entire volume of the diluted sample into a sample loop of an injection valve.

FIG. 7 is a simplified graphical representation of how the volume of diluted sample occupies the sample loop.

FIG. 8 shows the fluidic network configured to inject the volume of diluted sample into the system flow of the chromatography system.

FIG. 9 shows the fluidic network configured for part of a wash cycle used to wash any trace amount of the sample from the fluidic network.

### DETAILED DESCRIPTION

Reference in the specification to an “example,” “embodiment” or “implementation” means that a particular feature, structure or characteristic described in connection with the example, embodiment or implementation is included in at least one embodiment of the teaching. References to a particular example, embodiment or implementation within the specification do not necessarily all refer to the same embodiment.

As used herein, a mobile phase is a solvent or mixture of solvents used to carry a sample and to pass through the stationary phase of a liquid chromatography system. The mobile phase may be a gradient mobile phase in which the composition of the mobile phase changes with time. The mobile phase also is referred to herein as the system flow which typically flows from the source of the mobile phase to at least the detector of the liquid chromatography system.

As use herein, the word “sample” refers to a sample solution that contains the sample components to be injected into the system flow upstream from a chromatographic column. The sample is typically made available in a sample reservoir or other form of sample container in the sample manager of the liquid chromatography system. In some instances, the sample solution includes a sample diluent.

The term “sample loop” is used herein to refer broadly to any suitable container, vessel, conduit or tube that temporarily holds a volume of sample prior to injection and separation, including, for example, sample loops that are know to one having ordinary skill in high-pressure or high-performance liquid chromatography (“HPLC”) at pressures of approximately 7 to 14 MPa (1,000 to 2,000 psi) or greater, and ultra-high-pressure or ultra-high-performance liquid chromatography (“UHPLC”) at pressures of up to approximately 100 to 140 MPa (15,000 to 20,000 psi) or greater.

The term “sample needle” is used herein to refer to a needle at one end of a fluid path. The sample needle may be movable to a source of sample, for example, by a translation and/or rotation mechanism. In some instances, the sample needle may be used to pierce a sealing septum on a sample container. During sample acquisition, a volume of sample is drawn into the sample needle. In some instances, the sample needle includes a needle structure at one end of a fluid path and may include at least a portion of that fluid path. The fluid path may include flexible tubing to facilitate movement of the sample needle.

The term “fluid path” is used herein to refer broadly to any suitable conduit, capillary, tube or other channel for conveying a fluid. For example, a fluid path may be a channel coupled at each end to a component in a fluidic network such as a valve, solvent source and the like.

As used herein, a solvent is sometimes referred to as a “strong solvent” or a “weak solvent” to indicate the relative elution strength of the solvent with respect to one or more other solvents. If the mobile phase is a strong solvent, the sample dissolved in the strong solvent will have a greater affinity for the mobile phase than the stationary phase. A strong solvent is generally capable of dissolving a greater quantity of a sample than a weak solvent; however, with the use of a strong solvent there may be a shorter retention time and little or no retention of the sample on the stationary phase. In contrast, if the mobile phase is a weak solvent, the sample dissolved in the weak solvent will have a greater affinity for the stationary phase than the mobile phase. As a result, sample components are better retained on the stationary phase and have longer retention times. By way of non-limiting examples for reversed phase chromatography, solvents composed primarily of methanol, acetonitrile, ethanol, isopropanol or tetrahydrofuran are typically considered strong solvents whereas water is generally considered a weak solvent. By way of non-limiting examples for normal phase chromatography and supercritical fluid chromatography, hexane and heptane are generally considered weak solvents, and methanol, ethanol and water are typically considered strong solvents.

In brief overview, examples of a method for injecting a sample into a liquid chromatography system and a fluidic network for injecting a diluted sample into a liquid chromatography system are described. The method includes merging a flow of a strong solvent having a sample dissolved therein with a flow of a diluent. The merging occurs within the liquid chromatography system and avoids the need for sample preparation with dilution external to the system. The full amount of sample previously contained in a smaller volume of strong solvent is maintained in a larger volume of a diluted sample that includes the strong solvent and the diluent. The entire volume of the diluted sample is loaded into a sample loop and subsequently injected into the system flow of the chromatography system. Advantageously, the full sample mass can be loaded on the chromatography column and the separation yields improved chromatographic results, i.e., reduced distortion of chromatographic peaks.

The present disclosure will now be described in more detail with reference to embodiments thereof as shown in the accompanying drawings. While the present teaching is described in conjunction with various embodiments and examples, it is not intended that the present teaching be limited to such embodiments. On the contrary, the present disclosure encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure.

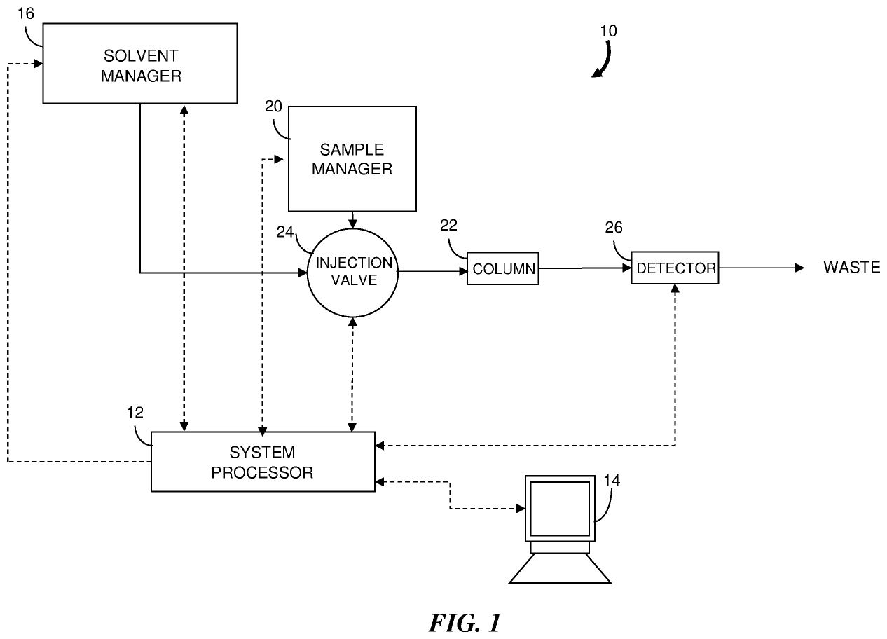

FIG. 1 is a block diagram of a liquid chromatography system 10 that can be used to practice embodiments of a method for injecting a sample into a liquid chromatography system. The system 10 includes a system processor 12 (e.g., microprocessor and controller) in communication with a user interface device 14 for receiving input parameters and displaying system information to an operator. The system processor 12 communicates with a solvent manager 16 which provides one or more solvents for a mobile phase. For example, the solvent manager 16 may provide a gradient mobile phase. A sample provided by a sample manager 20 is injected into the mobile phase upstream from a chromatographic column 22 at an injection valve 24. The sample manager 20 can include one or more sources of a sample such as a sample reservoir, vial or other container that holds a volume of the sample. In some embodiments, the sample manager 20 is a flow through needle sample manager that includes a sample needle and sample syringe used to aspirate a sample from a sample source. In some instances, the sample manager 20 provides a diluted sample that includes the sample and a diluent. The chromatographic column 22 is coupled to a detector 26 which provides a signal to the system processor 12. The signal is responsive to various components detected in the eluent from the column 22. After passing through the detector 26, the system flow exits to a waste port; however, when used for fraction collection, a diverter valve may be included to temporarily redirect the system flow to one or more collection vessels.

For many chromatographic separations, the sample concentration of the injected sample is important to obtaining quality chromatograms. For example, a highly-concentrated sample may overload the chromatographic column or may be so substantial as to exceed the linearity range of the detector. U.S. Patent Publication No. US 2019/0366325, incorporated herein by reference, describes systems and methods to overcome the concentration problem in which a sample volume is diluted, and a portion of the diluted sample volume is stored and then injected into the system flow. Only a portion of the diluted sample volume may be used to perform the chromatographic separation.

For some separations in which increased sensitivity is desired, a large sample volume may be injected. Sample preparation may include dissolving the sample in a strong solvent. The solvent may temporarily act as a strong mobile phase. Consequently, analytes of interest may be poorly retained or, in some instances, not retained as the analytes may pass through the column with the strong solvent. The result may be peak distortion in the chromatogram and the goal of enhancing analysis sensitivity is not achieved.

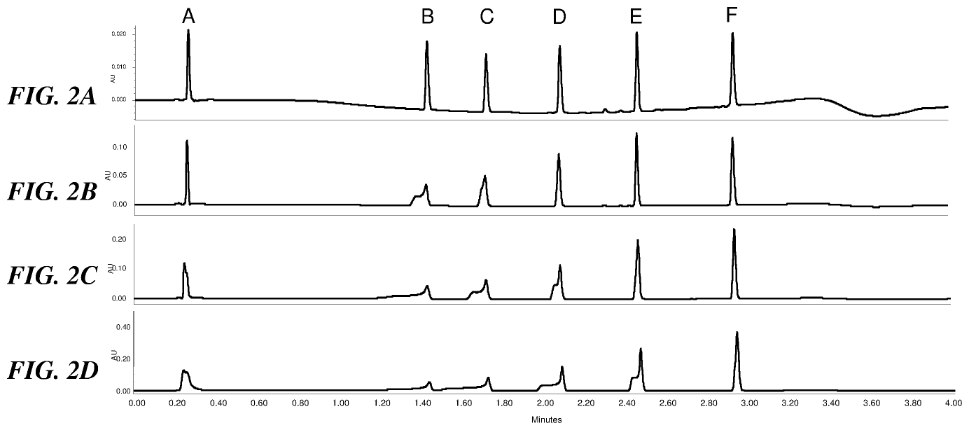

FIGS. 2A to 2D demonstrate how a strong solvent affects chromatographic performance. All four chromatograms were generated using a 1.7 μm BEH C18 2.1×50 mm column (available from Waters Corporation, Milford, Mass.) using a gradient mobile phase at 40° C. and a 0.5 μmL/min. flow rate. The gradient mobile phase components were water and acetonitrile and transitioned from 5% acetonitrile to 95% acetonitrile in 2.5 minutes.

FIG. 2A shows a chromatogram for a 1 μL sample dissolved in a solvent containing 5% acetonitrile and 95% water. FIG. 2B, FIG. 2C and FIG. 2D show chromatograms for 5 μL, 10 μL and 20 μL volumes of sample, respectively, dissolved in a solvent containing 75% acetonitrile. The sample composition for the chromatograms is given, in order of retention from A (least retained) to F (most retained), by:
A: thiourea (V0) 2 μg/mL
B: acetanilide 5 μg/mL
C: coumarin 2 μg/mL
D: benzoin 5 μg/mL
E: 1,1-bi-2-naphthol 0.8 μg/mL
F: dibutyl phthalate 6 μg/mL.

The chromatogram for the smallest sample volume (1 μL) in the weak solvent (5% acetonitrile) results in the chromatogram with the least peak distortion (FIG. 2A). The chromatograms for the strong solvent (75% acetonitrile) used with the three larger sample volumes exhibit significant peak distortion. Thus, the use of larger sample volumes in a strong solvent is insufficient for achieving enhanced analysis sensitivity.

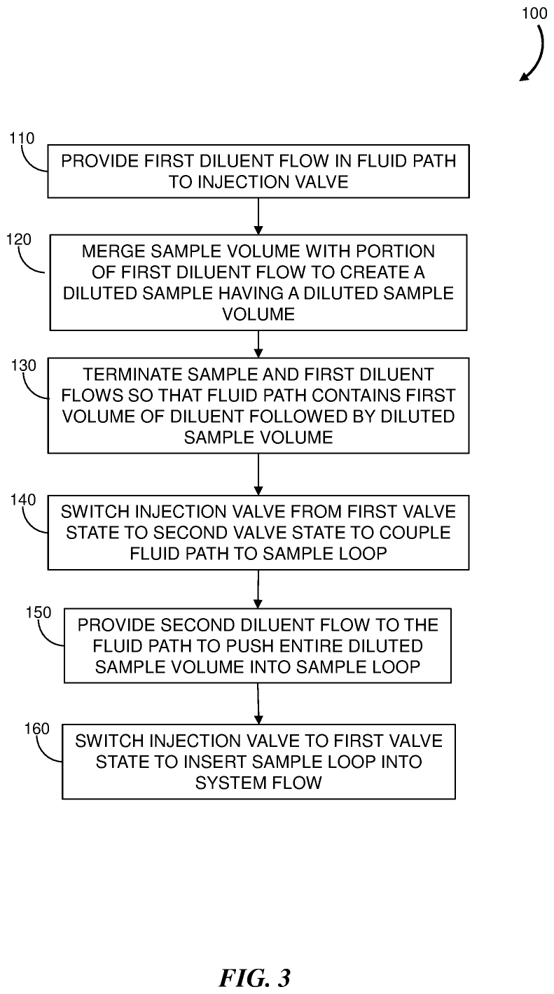

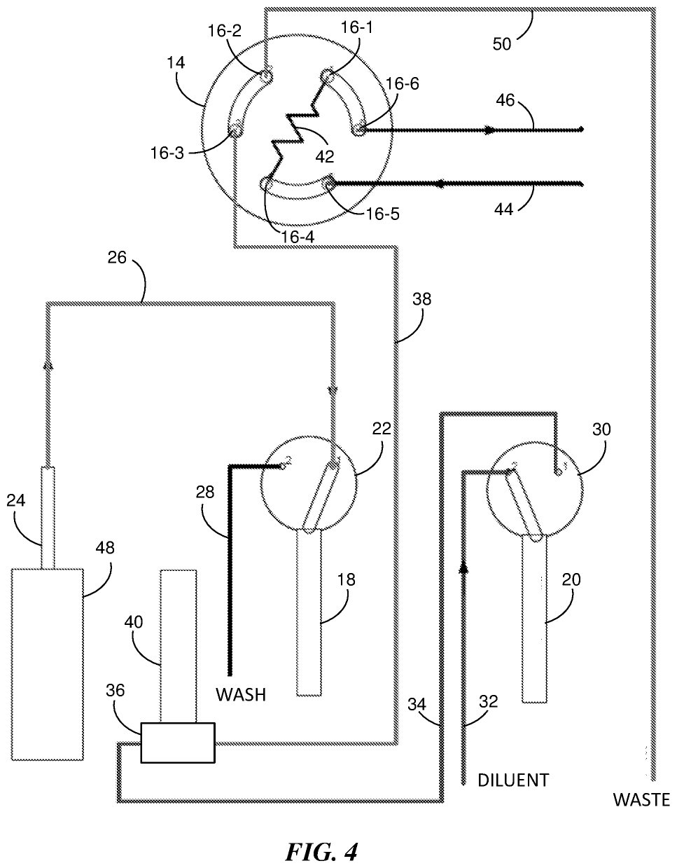

FIG. 3 is a flowchart representation of an example of a method 100 for injecting a sample in a liquid chromatography system. Reference is also made to FIG. 4 which shows a fluidic network that can be used to perform the method 100. Arrowheads in the fluid paths indicate the direction of fluid flow.

The fluidic network may include components of a sample manager of the liquid chromatography system. The fluidic network includes an injection valve 14 having a plurality of ports 16-1 to 16-6 to receive and/or dispense a liquid flow. For example, the injection valve 14 may be a six-port rotary shear seal valve configurable in either of two valve states. The fluidic network further includes a sample syringe 18 and a diluent syringe 20.

A sample syringe valve 22 configured in a first valve state couples the sample syringe 18 to a sample needle 24 through an intervening fluid path 26. When configured in a second valve state, the sample syringe valve 22 couples the sample syringe 18 to a source of wash solvent through fluid path 28. A diluent syringe valve 30 when configured in a first valve state couples the diluent syringe 20 to port 16-3 of the injection valve 14 through fluid path 34, injection block 36 and fluid path 38. When configured in a second valve state, as shown in the figure, the diluent syringe valve 30 couples the diluent syringe 20 to a source of diluent through fluid path 32. A wash tower 40 is fluidically coupled to the injection block 36 and is configured to receive the tip of the sample needle 24.

The injection valve 14 includes a sample loop 42 coupled to port 16-1 at one end and to port 16-4 at the other end. Port 16-2 is coupled to a fluid path 50 to conduct a flow exiting the port to waste. Port 16-5 is coupled through fluid path 44 to a solvent manager to receive a flow of mobile phase. Port 16-6 is coupled through fluid path 46 to a chromatographic column. As illustrated, the injection valve 14 is configured in a first valve state in which port 16-1 is coupled to port 16-6, port 16-2 is coupled to port 16-3 and port 16-4 is coupled to port 16-5. Thus, the flow of mobile phase received at port 16-6 flows through the sample loop 42 before leaving the injection valve 14 at port 16-5 and flowing to the chromatographic column.

Conventional sample loops for liquid chromatography typically have volumes that range from 0.01 μL to 5 μL. Preferably, the volume of the sample loop 42 is at least approximately 100 μL. In some embodiments, the volume of the sample loop 42 is approximately one milliliter or more.

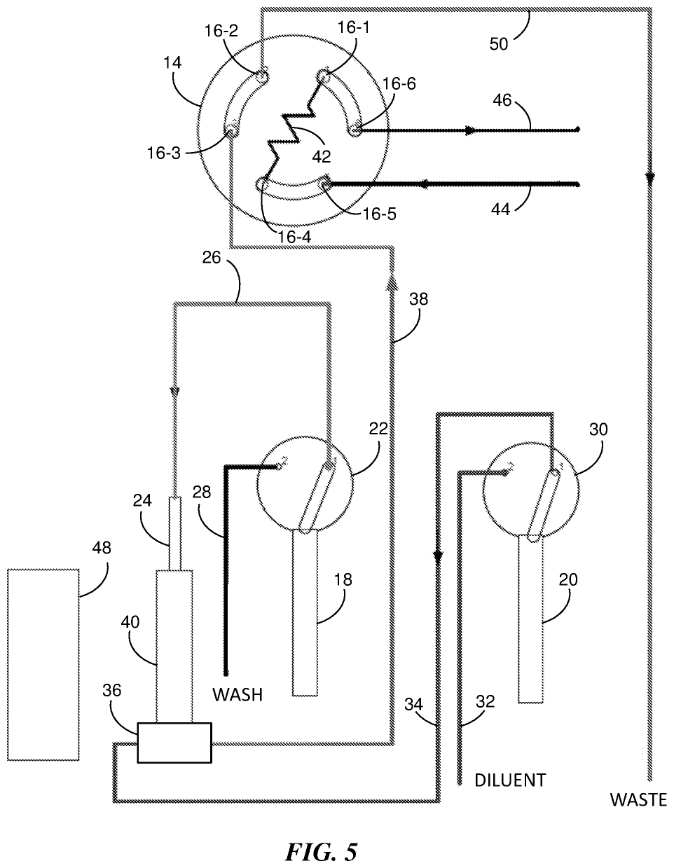

Tubing or other forms of conduit can be used for the fluid paths that couple various components of the fluidic network. Moreover, a control system (e.g., part of system processor 12 in FIG. 1) is used to control the valve states of the injection valve 14, sample syringe valve 22, and diluent syringe valve 30, and to control the position of the sample needle 24. For example, the sample needle 24 may be positioned as illustrated in a sample vial 48 to acquire a volume of sample for injection or may be positioned in the wash tower 40 and injection valve 36 (see, e.g., FIG. 5) for sample loading, injection and performing a wash process.

As illustrated, the sample syringe 18 is operated to aspirate sample from the sample vial 48 into the sample needle 24 and, optionally, partially into the fluid path 26 between the sample needle 24 and sample syringe valve 22. The volume of sample acquired can be precisely controlled through control of the sample syringe 18. The diluent syringe 20 is operated to aspirate diluent.

After a desired volume of sample is acquired, the sample needle 14 is removed from the sample vial 48 and moved to the wash tower 40 where it is inserted for coupling to the injection block 36, as shown in FIG. 5. In addition, the diluent syringe valve 30 is switched to the first valve state. Thus, the sample syringe 18 and the diluent syringe 20 are coupled to the injection block 36 and are in fluid communication with the injection valve 14 at port 16-3 through fluid path 38.

A diluent flow is provided (step 110) by the diluent syringe 20 to the injection valve 14 by dispensing the previously aspirated diluent. A sample volume is merged (step 120) with a portion of the diluent flow at the injection block 36 to create a diluted sample in the fluid path 38. The diluted sample has a diluted sample volume that is equal to the sum of the merged volumes of sample and diluent. In one implementation, the sample volume that is merged may be the entirety of the sample volume acquired from the sample vial 48 using the sample syringe 18. Alternatively, only a portion of the acquired sample volume may be merged by controlling the sample syringe 22 to dispense a smaller volume. Once the sample volume to be injected has passed through the injection block 36 into the fluid path 38, the flows from the sample syringe 18 and the diluent syringe 20 are terminated (step 130). Termination can be simultaneous or the diluent syringe 20 may be deactivate later such that a small volume of the diluent may “follow” the diluted sample volume in the fluid path 38.

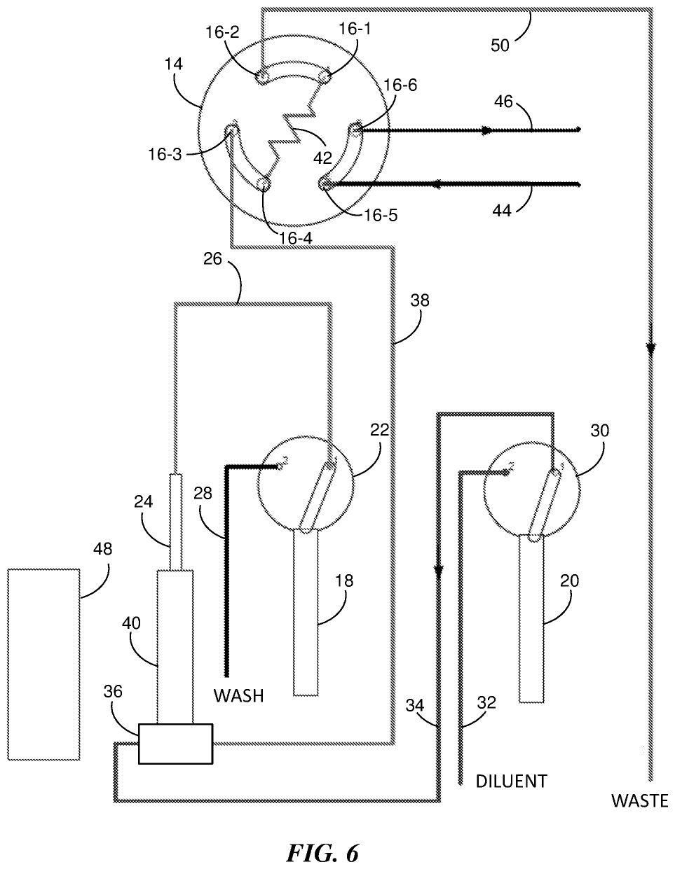

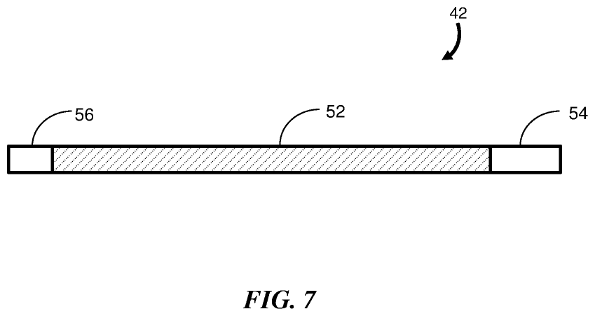

To load the diluted sample volume into the sample loop 42, the injection valve 14 is switched (step 140) to its second valve state (i.e., “load state”) as shown in FIG. 6. The diluent syringe 20 is then operated to push (step 150) diluent into fluid path 34, injection block 36 and fluid path 38. The volume of diluent supplied by the diluent syringe 20 during the load operation is chosen so that the entire diluted sample volume is pushed into and remains in the sample loop 42. FIG. 7 shows a simplified graphical representation of how the diluted sample occupies the sample loop 42. The length and the area of the full rectangle (shaded and unshaded regions) represent the length and the volume, respectively, of the sample loop 42. The direction of fluid flow for loading the diluted sample volume is from left to right in the figure. The diluted sample volume is represented by the shaded region 52 and is preceded at one end of the sample loop by a volume 54 of diluent from the diluent flow initiated prior to the actuation of the sample syringe 18 for merging. A volume of diluent 56 resulting from the diluent flow occurring after termination of the sample flow follows the diluted sample and occupies the other end of the sample loop.

The volume of the sample loop 42 is chosen to exceed the largest diluted sample volume for injection into the chromatography system. As illustrated, the diluted sample volume is nominally centered along the length of the sample loop 42; however, this is not a requirement and, in other implementations, the diluted sample volume may reside substantially closer to one end of the sample loop 42. In one embodiment, the volume of the sample loop may be at least 100 μL. In alternative embodiments, the volume of the sample loop may exceed one milliliter.

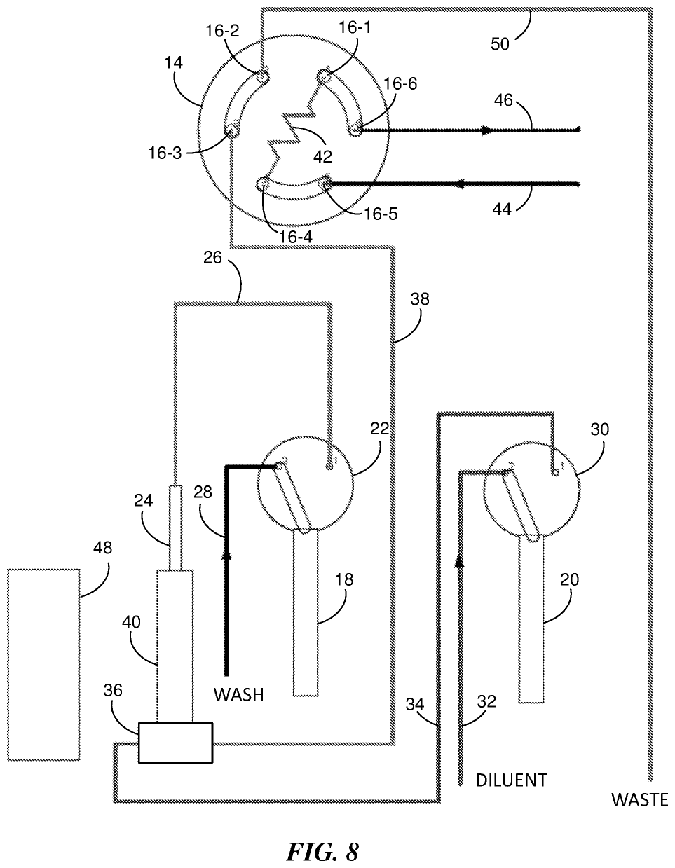

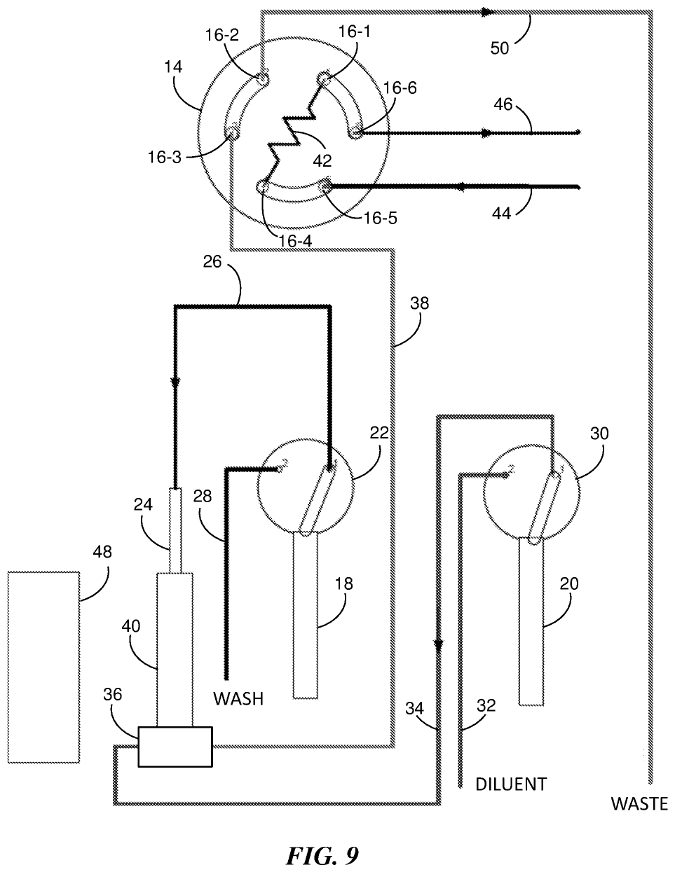

To inject the diluted sample volume into the system flow of the chromatography system, the injection valve 14 is switched (step 160) to the first valve state, as shown in FIG. 8. The system flow received at port 16-6 of the injection valve 14 then passes through the sample loop 42 pushing its contents, including the diluted sample volume, out through port 16-5 toward the chromatographic column. The sample syringe valve 22 and the diluent syringe valve 30 are switched to their second valve states, as shown in the figure. The sample syringe 18 operates to refill with wash solvent and the diluent syringe 20 is operated to refill with diluent. Subsequently, the sample syringe valve 22 and the diluent syringe valve 30 are switched to their first valve states, as shown in FIG. 9. The sample syringe 18 and diluent syringe 20 then operate to dispense wash solvent and diluent, respectively, to wash away any trace amounts of the sample that remain in the injection block 36 and fluid paths 26 and 38. This wash process avoids cross-contamination for the next separation to be performed. The process of refilling the sample syringe 18 and diluent syringe 20 and subsequently dispensing the refilled wash solvent and diluent can be repeated one or more times, if desired, for better removal of trace amounts of sample.

While the technology has been shown and described with reference to specific embodiments, it should be understood by those skilled in the art that various changes in form and detail may be made therein without departing from the scope of the claims.

What is claimed is:

1. A method for injecting a sample into a liquid chromatography system, the method comprising:
providing a first diluent flow in a fluid path coupled to an injection valve having a plurality of ports and a sample loop coupled between two of the ports, the injection valve being in a first valve state to conduct a chromatography system flow through the sample loop, the fluid path having an end coupled to one of the ports,
merging a sample flow with the first diluent flow to create a flow of a diluted sample in the fluid path, the sample flow comprising a sample dissolved in a solvent and the diluted sample having a diluted sample volume;
terminating the sample flow and the first diluent flow so that the fluid path contains a first volume of diluent followed by the diluted sample;
switching the injection valve to a second valve state in which the fluid path is coupled to the sample loop;
providing a second diluent flow to the fluid path to push an entirety of the diluted sample from the fluid path into the sample loop, wherein at least a portion of the diluent in the first diluent flow and a portion of the diluent in the second diluent flow are in the sample loop; and
switching the injection valve to the first valve state, wherein the sample loop is inserted into the system flow to thereby inject the entirety of the diluted sample volume into the system flow.

2. The method of claim 1 further comprising drawing the sample from a sample source prior to merging the sample flow with the portion of the first flow of the diluent.

3. The method of claim 1 wherein the sample volume is at least 1 microliter.

4. The method of claim 1 wherein the first diluent flow and the second diluent flow are flows of a same diluent.

5. The method of claim 1 wherein the sample flow and the first diluent flow are terminated at a same time.

6. The method of claim 1 wherein the sample flow is terminated before the first diluent flow so that the fluid path contains a first volume of diluent followed by the diluted sample volume followed by a second volume of diluent.

7. The method of claim 1 wherein the diluted sample has a diluted sample volume that is equal to the sum of the merged volumes of sample and diluent.

8. The method of claim 1 further comprising providing a flow of a wash solvent through the fluid path coupled to the injection valve.

9. A fluidic network for injecting a diluted sample into a liquid chromatography system, comprising:
an injection valve having a plurality of ports wherein one of the ports is configured to receive a system flow of a liquid chromatography system and another one of the ports is configured to provide the system flow, the injection valve being configurable in at least two valve states and comprising a sample loop coupled at each end to one of the ports;
a sample needle;
an injection block;
a sample syringe configured to aspirate and to dispense a sample;
a sample syringe valve operable in at least two valve states, wherein, when the sample syringe valve is in a first valve state, the sample syringe is coupled to the sample needle;
a diluent syringe configured to aspirate and to dispense a diluent;
a diluent syringe valve operable in at least two valve states, wherein, when the diluent syringe valve is in a first valve state, the diluent syringe is coupled through the injection block and a fluid path to a port of the injection valve and wherein, when the diluent syringe valve is in a second valve state, the diluent syringe is coupled to a source of diluent; and
a processor in communication with the injection valve, the sample syringe and the diluent syringe, the processor controlling the valve state of the injection valve, a flow rate of a sample flow from the sample syringe and a flow rate of a diluent flow from the diluent syringe.

10. The fluidic network of claim 9 and wherein, when the sample syringe valve is in a second valve state, the sample syringe is coupled to a source of wash solvent.

11. The fluidic network of claim 9, wherein the sample needle is movable to enable coupling of the sample syringe valve to the injection block and to a source of sample.

12. The fluidic network of claim 9, wherein the sample loop has a volume of at least 10 microliters.

13. The fluidic network of claim 9, wherein the sample loop has a volume that does not exceed one milliliter.

14. The fluidic network of claim 9 further comprising a wash tower coupled to the injection block and configured to receive the sample needle.

15. A fluidic network for injecting a diluted sample into a liquid chromatography system, comprising:
an injection valve having a plurality of ports wherein one of the ports is configured to receive a system flow of a liquid chromatography system and another one of the ports is configured to provide the system flow, the injection valve being configurable in at least two valve states and comprising a sample loop coupled at each end to one of the ports;
a sample needle;
a sample syringe in communication with the sample needle and configured to aspirate a sample through the sample needle and to dispense a sample into a fluid path to the injection valve;
a diluent syringe configured to aspirate a diluent from a source of diluent and to dispense the diluent into the fluid path to the injection valve; and
a processor in communication with the injection valve, the sample syringe and the diluent syringe, the processor controlling the valve state of the injection valve, a flow rate of a sample flow from the sample syringe and a flow rate of a diluent flow from the diluent syringe, wherein a diluted sample is created by a merging of the sample flow and the diluent flow in the fluid path to the injection valve.

16. The fluidic network of claim 15, wherein the sample loop has a volume of at least 100 microliters.

17. The fluidic network of claim 15, wherein the sample needle is movable to enable coupling of the sample syringe valve to the fluid path to the injection valve and to a source of sample.
